(19) United States
(12) Patent Application Publication
(10) Pub. No.: US 2013/0103914 A1
(43) Pub. Date: Apr. 25, 2013

(54) APPARATUS, METHOD, AND STORAGE MEDIUM FOR SAMPLING DATA

(71) Applicant: Fujitsu Limited, Kawasaki-shi (JP)

(72) Inventors: Hideki Mitsunobu, Kawasaki (JP); Toshihiko Kurita, Kawasaki (JP)

(73) Assignee: FUJITSU LIMITED, Kawasaki-shi (JP)

(21) Appl. No.: 13/655,681

(22) Filed: Oct. 19, 2012

(30) Foreign Application Priority Data
Oct. 25, 2011 (JP) 2011-234423

(51) Int. Cl. G06F 12/00

(52) U.S. Cl. 711/154; 711/E12.001

(57) ABSTRACT

A data sampling apparatus includes a plurality of first-in first-out memories and a processor that executes a procedure. The procedure includes classifying received data signals in accordance with types of the data signals; storing the classified data signals in the corresponding memories; calculating a sampling rate based on a ratio between a total traffic volume of the received data signals per given time and a traffic volume of data signals stored in each of the memories per given time; and sampling the data signals stored in each of the memories based on the corresponding calculated sampling rate.

### CROSS-REFERENCE TO RELATED APPLICATION

This application is based upon and claims the benefit of priority of the prior Japanese Patent Application No. 2011-234423, filed on Oct. 25, 2011, the entire contents of which are incorporated herein by reference.

### FIELD

The embodiment discussed herein relates to an apparatus, method, and storage medium for sampling data to monitor the traffic of data signals propagating through a network.

### BACKGROUND

In the construction of a large system in which virtual machines run, multiple servers are connected to a network. The network configuration becomes more complicated as the system size increases. A traffic management technology such as sFlow® is used to manage a complicated network.

Where traffic is managed using sFlow®, a node provided with a monitoring function of sFlow® samples data passing through the node. Based on the data sampled, the node transmits monitoring information such as the communication volume or header information to a sFlow® management node. The management node can manage the traffic of the entire system based on management information received from each node. Known as the related art are Japanese Laid-open Patent Publication Nos. 2005-51736, 2006-345345, and 2008-141565.

### SUMMARY

According to an aspect of the invention, an A data sampling apparatus includes a plurality of first-in first-out memories and a processor that executes a procedure. The procedure includes classifying received data signals in accordance with types of the data signals; storing the classified data signals in the corresponding memories; calculating a sampling rate based on a ratio between a total traffic volume of the received data signals per given time and a traffic volume of data signals stored in each of the memories per given time; and sampling the data signals stored in each of the memories based on the corresponding calculated sampling rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a wireless communication system;

FIG. 2 is a diagram illustrating function blocks of a switch (SW);

FIG. 3 is a block diagram illustrating the hardware of the switch (SW);

FIG. 4A illustrates a classification table;

FIG. 4B illustrates packet signals received by the switch (SW);

FIG. 4C illustrates packet signals distributed to queues;

FIG. 5 is a graph illustrating the error rate with respect to the number of sampled packet signals; and

FIG. 6 is a sequence diagram illustrating sampling control of packet signals by the switch (SW).

### DESCRIPTION OF EMBODIMENTS

The accuracy of monitoring information such as the communication volume or header information of a packet is increased as the number of sampled pieces of data is increased. If packet signals passing through a port to be monitored are of multiple data types and the reception frequency of a packet signal varies among the data types, the accuracy of monitoring information about a packet signal of a data type with a lower reception frequency is lower. The accuracy of entire monitoring information varies depending on the traffic volume of packet signals passing through the port to be monitored.

In this embodiment, a monitoring information accuracy not less than a given value is accomplished regardless of the data type of a packet signal and the total traffic volume.

Hereafter, this embodiment will be described. Note that a combination of components of embodiments also constitutes an embodiment.

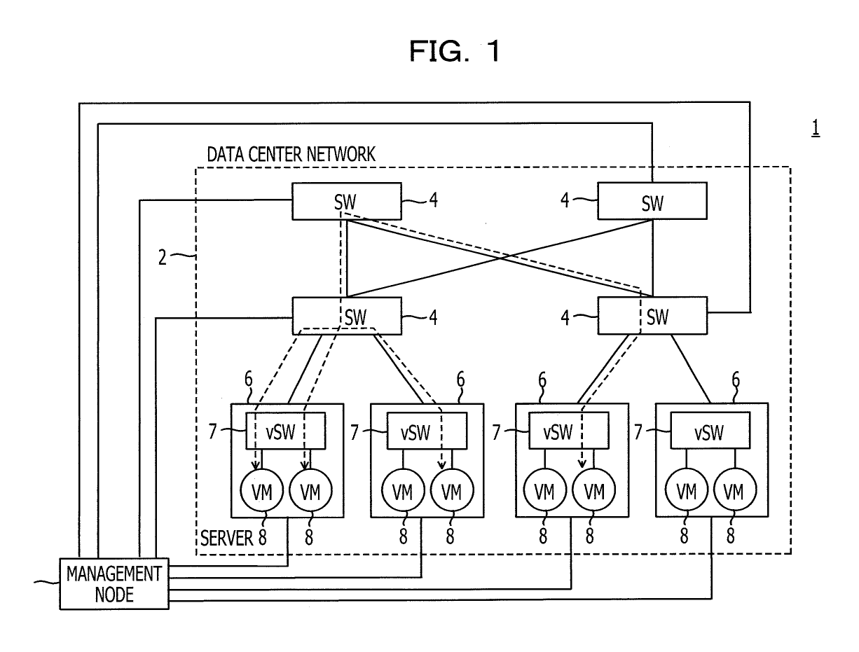

FIG. 1 is a system configuration diagram of a data center 1. The data center 1 is a system where multiple nodes are connected to a network and thus share resources. The data center 1 includes a data center network 2 and a management node 3. The management node 3 is a node for managing traffic in the data center network 2. It is assumed in this embodiment that data signals are packet signals which propagate in units of packets.

The data center network 2 includes switches (SWs) 4 and servers 6. Each SW 4 selects the destinations of packet signals propagating through the network. Each server 6 provides resources to multiple users.

Each server 6 includes a virtual switch (vSW) 7 and virtual machines (VMs) 8. Each vSW 7 is a virtual switch that runs on a corresponding server 6. Each VM 8 is a virtual machine that runs on a corresponding server 6. By running multiple VMs 8 on a single server 6, the single server 6 can run multiple operating systems (OSs) or different pieces of architecture software thereon.

The management node 3 is connected to the SWs 4 and the servers 6 via a management network. Each SW 4 and each server 6 transmit traffic monitoring information to the management node 3 using, e.g., sFlow®. The management node 3 manages the entire data center network 2 based on monitoring information received from the SWs 4 and servers 6.

As illustrated in this embodiment, the management network may be provided independently of a packet signal network for transmitting packet signals. Providing the management network independently of the packet signal network allows stable traffic management to be performed regardless of the traffic of packet signals.

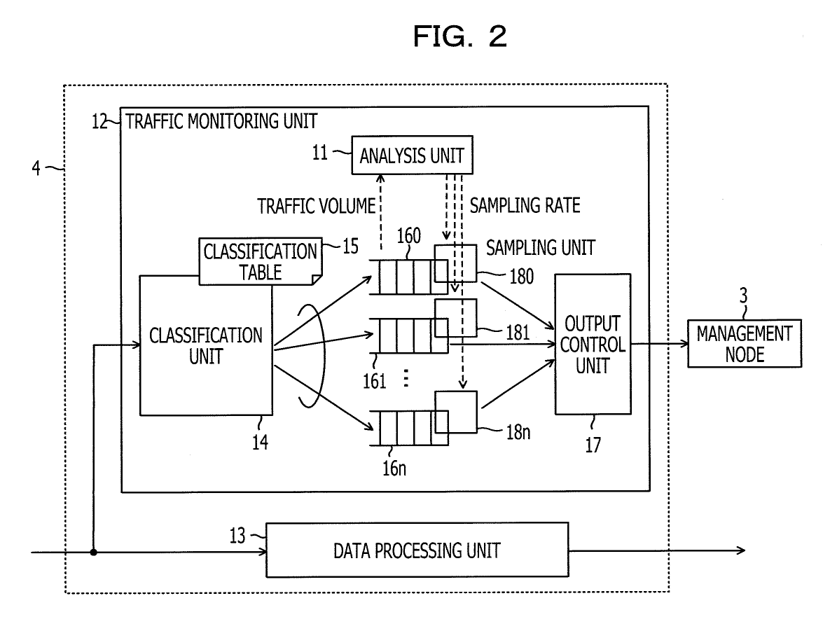

FIG. 2 is a diagram illustrating function blocks of a switch (SW) 4. The SW 4 includes a traffic monitoring unit 12 and a data processing unit 13.

The traffic monitoring unit 12 monitors the traffic of packet signals passing through the SW 4. In this embodiment, the traffic monitoring unit 12 is included in the SW 4; alternatively, it may be a traffic monitor which is independent of the SW 4.

The data processing unit 13 outputs a packet signal inputted to one port of the SW 4 from another port. In this embodiment, the data processing unit 13 included in the SW 4 has a switch function. The data processing unit 13 may perform a data processing function of a hub or router.

The traffic monitoring unit 12 includes a classification unit 14, a classification table 15, an analysis unit 11, queues 160 to 16n, sampling units 180 to 18n, and an output control unit 17.

The classification unit 14 classifies packet signals inputted to the SW 4 by data type based on the classification table 15 and stores the classified packet signals in the queues 160 to 16n. The classification table 15 defines the data types of packet signals and the destination queues 160 to 16n corresponding to the data types. As used herein, n is an integer starting from “0”. Details of the classification table 15 will be described later.

The queues 160 to 16n are first-in first-out (FIFO) storage units. Upon receipt of the packet signals classified by the classification unit 14, the queues 160 to 16n each transmit to the analysis unit 11 a notification signal indicating that it has received a packet signal.

The analysis unit 11 records the number of notifications signals received from each queue. The analysis unit 11 periodically calculates data type-specific traffic volumes with respect to the total number of packets based on the sum of the numbers of notification signals received from the queues 160 to 16n, as well as based on the data type-specific notification signals received from the queues 160 to 16n. Based on the data type-specific traffic volumes calculated, the analysis unit 11 determines sampling rates corresponding to the data types. The method of determining sampling rates based on the traffic volumes calculated will be described in detail later. In this embodiment, the data type-specific sampling rates are determined based on the numbers of received notification signals, alternatively, the data type-specific sampling rates may be determined by periodically calculating the traffic volumes of packet signals.

The analysis unit 11 transmits rate signals indicating the determined sampling rates to the sampling units 180 to 18n which are provided with the queues 160 to 16n, respectively. The sampling units 180 to 18n sample the data type-specific packet signals accumulated in the queues 160 to 16n at the sampling rates indicated by the rate signals. The sampling units 180 to 18n transmit the sampled packet signals (hereafter referred to as the sampled signals) to the output control unit 17. The sampling units 180 to 18n may transmit some or all of the sampled signals to the output control unit 17. Transmitting some of the sampled signals reduces the volume of network traffic from the SW 4 to the management node 3.

The output control unit 17 transmits the multiple sampled signals received from the sampling units 180 to 18n to the management node 3 in the form of a single signal. The output control unit 17 is, for example, a multiplexer.

As seen, the traffic monitoring unit 12 optimizes the data type-specific sampling rates based on the data types of packet signals. Thus, it accomplishes a monitoring information accuracy not less than a given value, regardless of the packet type and the total traffic volume.

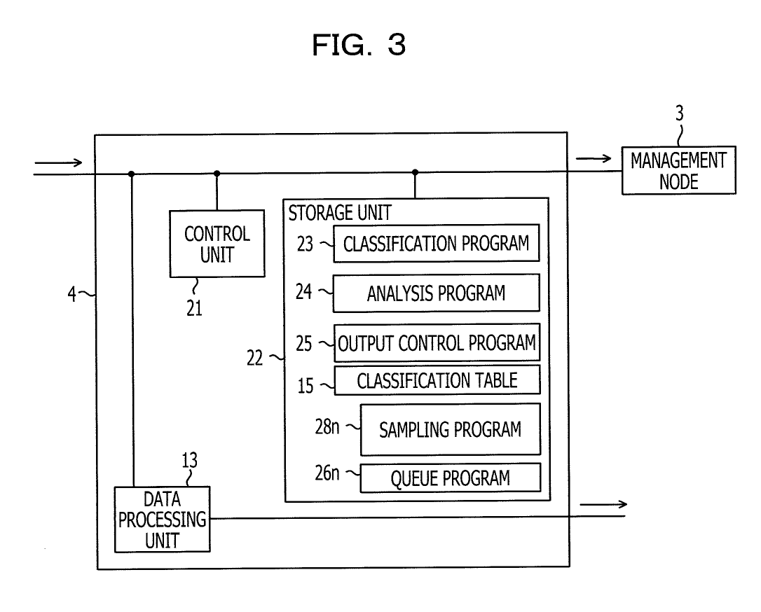

FIG. 3 is a hardware block diagram of a switch (SW) 4. The SW 4 includes the control unit 21, the storage unit 22, and the data processing unit 13.

Stored in the storage unit 22 is a classification program 23, an analysis program 24, an output control program 25, the classification table 15, a sampling program 28n, and a queue program 26n.

The control unit 21 executes the programs stored in the storage unit 22 to achieve various functions. The control unit 21 serves as the classification unit 14 by executing the classification program 23 read from the storage unit 22. The control unit 21 serves as the analysis unit 11 by executing the analysis program 24 read from the storage unit 22. The control unit 21 serves as the output control unit 17 by executing the output control program 25 read from the storage unit 22. The control unit 21 serves as the sampling units 180 to 18n by executing the sampling program 28n read from the storage unit 22. The control unit 21 serves as the queues 160 to 16n by executing the queue program 26n read from the storage unit 22. The control unit 21 may be, for example, a processor such as a central processing unit (CPU) or digital signal processor (DSP). The storage unit 22 may be a non-volatile storage unit (e.g., read only memory (ROM)). The storage unit 22 may include a non-volatile storage unit (e.g., ROM) and a volatile storage unit (e.g., random access memory (RAM)) to which various programs read from the non-volatile storage unit are to be loaded.

As with the traffic monitoring unit 12, the data processing unit 13 may be accomplished by executing a data processing program stored in the storage unit 22 using the control unit 21 or by using a control unit and storage unit that are independent of the traffic monitoring unit 12. Such control unit and storage unit may be various types of processor and storage unit as described above.

As seen, the SW 4 can accomplish the desired functions by executing the programs stored in the storage unit 22 using the control unit 21. The SW 4 may be realized in the form of an integrated circuit such as an application specific integrated circuit (ASIC).

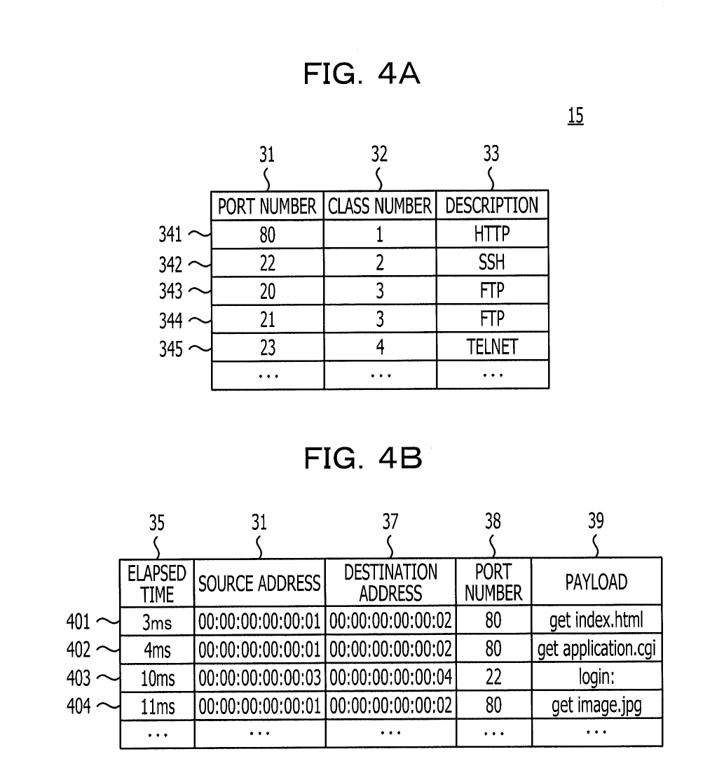

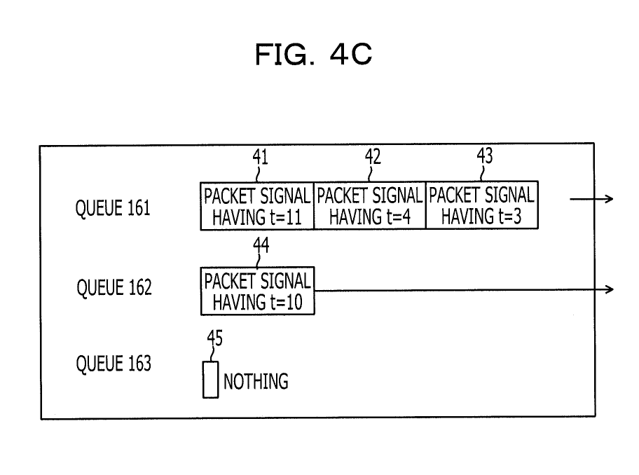

FIGS. 4A to 4C are diagrams illustrating a process of distributing packet signals received by the SW 4 to the queues 160 to 16n based on the classification table 15. FIG. 4A illustrates the classification table 15. FIG. 4B illustrates packet signals received by the switch (SW) 4. FIG. 4C illustrates packet signals distributed to the queues 160 to 16n.

In the classification table 15 illustrated in FIG. 4A, a column 31 illustrates port numbers. A port number refers to a number for designating one of multiple programs running on another computer as a communication destination. A column 32 illustrates class numbers. The class numbers represent the distribution destinations, the queues 160 to 16n. Each class number corresponds to the number “n” of the queues 160 to 16n in the SW 4 of FIG. 2. A column 33 illustrates descriptions of packets corresponding to the port numbers in the column 31.

In FIG. 4A, a row 341 indicates that a packet signal having a port number “80” is distributed to the queue 161 having a class number “1” and that this packet signal is transferred by HTTP (hypertext transfer protocol). A row 342 indicates that a packet signal having a port number “22” is distributed to the queue 162 having a class number “2” and that this packet signal is transferred by secure shell (SSH). Rows 343 and 344 indicate that packet signals having port numbers “20” and “21” are distributed to the queue 163 having a class number “3” and that these packet signals are transferred by file transfer protocol (FTP). A row 345 indicates that a packet signal having a port number “23” is distributed to the queue 164 having a class number “4” and that this packet signal is transferred by Telnet.

In FIG. 4B, a column 35 illustrates time periods that have elapsed since reception of packet signals by the SW 4. A column 36 illustrates the source addresses of the packet signals. A column 37 illustrates the destination addresses of the packet signals. While the source and destination addresses are represented by MAC addresses in this embodiment, they may be represented by IP addresses.

A column 38 illustrates port numbers. The port numbers in the column 38 correspond to the port numbers in the column 31 of the classification table 15 illustrated in FIG. 4A. A column 39 illustrates payloads. A payload here refers to a data body obtained by excluding the header from a packet signal.

In FIG. 4B, a row 401 indicates that when 3 ms elapses after a packet signal having a payload “get index.html” is received, the packet signal will be transmitted from a node having an address “00:00:00:00:00:01” to a node having an address “00:00:00:00:00:02” and received at a port number “80”. A row 402 indicates that when 4 ms elapses after a packet signal having a payload “get application.cgi” is received, the packet signal will be transmitted from the node having an address “00:00:00:00:00:01” to the node having an address “00:00:00:00:00:02” and received at a port number “80”. A row 403 indicates that when 10 ms elapses after a packet signal having a payload “login:” is received, the packet signal will be transmitted from a node having an address “00:00:00:00:00:03” to a node having an address “00:00:00:00:00:04” and received at a port number “22”. A row 404 indicates that when 11 ms elapses after a packet signal having a payload “get image.jpg” is received, the packet signal will be transmitted from the node having an address “00:00:00:00:00:01” to the node having an address “00:00:00:00:00:02” and received at a port number “80”.

FIG. 4C illustrates a state in which the packet signals illustrated in FIG. 4B are classified and stored in the queues 160 to 16n based on the classification table 15 illustrated in FIG. 4A. Since the queues 160 to 16n are FIFO memory areas, older pieces of data are sequentially taken out.

In FIG. 4B, the port numbers of the packet signals in rows 401, 402, and 404 are “80”. In FIG. 4A, the class number of the port number “80” is “1”. Accordingly, as with packet signals 41, 42, and 43 in FIG. 4C, the packet signals illustrated in rows 401, 402, and 404 of FIG. 4B are stored in the queue 161.

The port number of the packet signal in row 403 is “22”. In FIG. 4A, the class number of the port number “22” is “2”. Accordingly, as with a packet signal 44 in FIG. 4C, the packet signal illustrated in row 403 of FIG. 4B is stored into the queue 162. Since FIG. 4B indicates that no packet signal having a port number “20” has been received, no packet signal is stored in the queue 163.

As seen, the SW 4 distributes the packet signals to the queues 160 to 16n corresponding to the data types based on the port numbers of the received packet signals and the classification table 15.

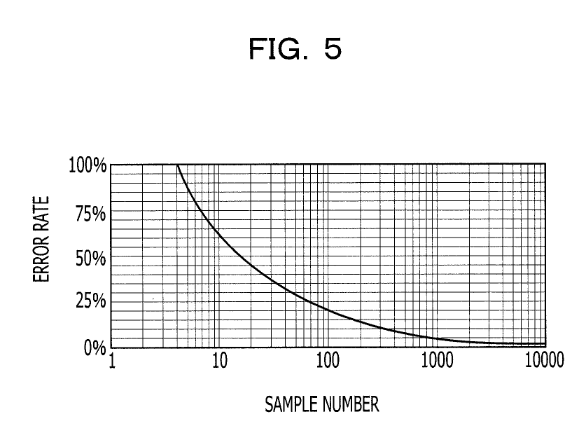

FIG. 5 is a graph illustrating an error ratio with respect to the number of sampled packet signals. As illustrated in FIG. 5, the error rate of the SW 4 is proportional to the reciprocal of the square of the sample number.

In this embodiment, the SW 4 classifies received packet signals by port number and changes the sample number in accordance with the number of packet signals corresponding to each port number. Accordingly, when the number of packet signals having a certain port number is small, the number of samples is increased. As a result, the time to be taken to reach a sample number such that the error rate becomes a value not more than a given value is reduced.

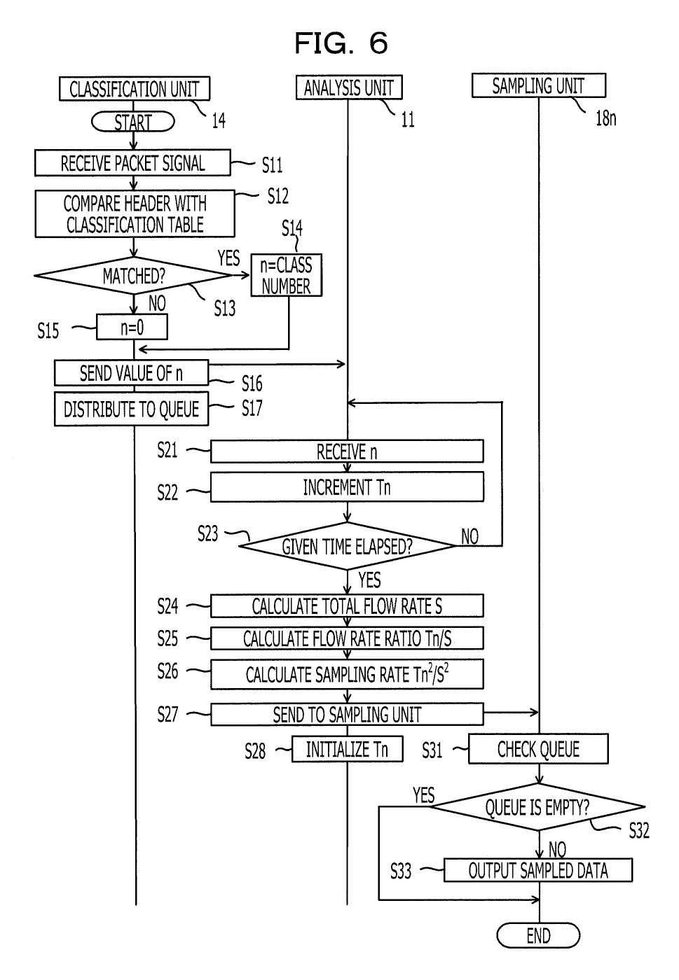

FIG. 6 is a sequence diagram illustrating sampling control of packet signals by the switch (SW) 4. The sample number control of packet signals corresponding to each data type in the SW 4 is performed by the classification unit 14, the analysis unit 11, and the sampling units 180 to 18n.

The classification unit 14 receives a packet signal transmitted by an external node (S11). The classification unit 14 compares the port number in the header of the received packet signal with the port numbers in the classification table 15 (S12). When the port number in the header and any one of the port numbers in the classification table 15 are matched (YES in S13), the classification unit 14 inputs a class number corresponding to the port number in the classification table 15 to a variable n (S14). When the port number in the header and none of the port numbers in the classification table 15 are matched (NO in S13), the classification unit 14 inputs “0” to the variable n (S15).

The classification unit 14 sends the value inputted to the variable n, to the analysis unit 11 (S16). The classification unit 14 also distributes the packet signal to a queue corresponding to the variable n, which is one of the queues 160 to 16n (S17).

As seen, the classification unit 14 distributes the received packet signal to one of the queues 160 to 16n based on the header of the packet signal and the classification table 11.

The analysis unit 11 receives the variable n sent by the classification unit 14 (S21). The analysis unit 11 increments a variable Tn corresponding to the received variable n by “1”. The analysis unit 11 determines whether given time has elapsed since reception of n (S23). If the given time has elapsed (NO in S23), the analysis unit 11 repeatedly receives the variable n sent by the classification unit 14. If the given time has elapsed (YES in S23), the analysis unit 11 calculates the sum of the variables Tn, a total flow rate S (S24). In the determination step S23, the analysis unit 11 may make the determination based on whether the volume of received traffic has become a given value or more.

The analysis unit 11 calculates a flow rate ratio Tn/S, which is the ratio of each Tn to the sum of the variables Tn, the total flow rate S (S25). As described above, the error rate is proportional to the reciprocal of the square of the data sample number. Thus, the analysis unit 11 calculates a sampling rate Tn²/S² (S26). Determining the sampling rate based on the square of the flow rate ratio allows a more appropriate sampling rate to be set for each data type.

The analysis unit 11 sends the calculated sampling rate to a sampling unit corresponding to the variable n, which is one of the sampling units 180 to 18n (S27). After calculating the sampling rate, the analysis unit 11 initializes the variable Tn (S28).

As seen, the analysis unit 11 calculates a sampling rate corresponding to the data type of a packet signal.

A sampling unit (one of 180 to 18n) that has received the sampling rate based on the variable Tn from the analysis unit 11 checks the memory area of a corresponding queue (one of 160 to 16n) (S31). If the queue is empty (YES in S32), the sampling unit completes the sampling process. If the queue is not empty (NO in S32), the sampling unit outputs data sampled from the corresponding queue to the output control unit 17 based on the sampling rate received from the analysis unit 11 (S33). The sampling units 180 to 18n each perform the above-mentioned process and output the sampled data to the output control unit 17 (S33).

As seen, the sampling units 180 to 18n output the pieces of data sampled from the packet signals accumulated in the queues 160 to 16n to the output control unit 17 based on the sampling rates sent by the analysis unit 11.

As seen, since the traffic monitoring unit 12 of the SW 4 includes the classification unit 14, the analysis unit 11, and the sampling units 180 to 18n, it samples data based on the optimum sampling rates corresponding to the data type-specific traffic volumes of received packet signals.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A data sampling apparatus comprising:
a plurality of first-in first-out memories; and
a processor that executes a procedure, the procedure including:
classifying received data signals in accordance with types of the data signals;
storing the classified data signals in the corresponding memories;
calculating a sampling rate based on a ratio between a total traffic volume of the received data signals per given time and a traffic volume of data signals stored in each of the memories per given time; and
sampling the data signals stored in each of the memories based on the corresponding calculated sampling rate.

2. The data sampling apparatus according to claim 1, wherein
the sampling rate is calculated based on a value obtained by squaring the ratio between the total traffic volume and the traffic volume of the data signals stored in each of the memories.

3. A method of sampling data, the method comprising:
classifying received data signals in accordance with types of the data signals;
storing the classified data signals in a plurality of corresponding first-in first-out memories;
calculating a sampling rate based on a ratio between a total traffic volume of the received data signals per given time and a traffic volume of data signals stored in each of the memories per given time; and
sampling the data signals stored in each of the memories based on the corresponding calculated sampling rate.

4. The method according to claim 3, wherein
the sampling rate is calculated based on a value obtained by squaring the ratio between the total traffic volume and the traffic volume of the data signals stored in each of the memories.

5. A computer-readable recording medium storing a program for causing an apparatus to execute a procedure, the procedure comprising:
classifying received data signals in accordance with types of the data signals;
storing the classified data signals in a plurality of corresponding first-in first-out memories;
calculating a sampling rate based on a ratio between a total traffic volume of the received data signals per given time and a traffic volume of data signals stored in each of the memories per given time; and
sampling the data signals stored in each of the memories based on the corresponding calculated sampling rate.

6. The computer-readable recording medium according to claim 5, wherein
the sampling rate is calculated based on a value obtained by squaring the ratio between the total traffic volume and the traffic volume of the data signals stored in each of the memories.
